(19) United States
(12) Patent Application Publication
(10) Pub. No.: US 2009/0066529 A1
(43) Pub. Date: Mar. 12, 2009

(54) REMAINING BATTERY LEVEL MANAGEMENT SYSTEM AND METHOD OF CONTROLLING THE SAME

(75) Inventor: Shinichi FUKADA, Hamura (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/185,227

(22) Filed: Aug. 4, 2008

(30) Foreign Application Priority Data
Sep. 7, 2007 (JP) 2007-233086

(51) Int. Cl. G08B 21/00

(52) U.S. Cl. 340/657

(57) ABSTRACT

A remaining battery level management system includes a battery-driven measurement device and a data collection server device. The measurement device includes: a communication data generation section that generates communication data to be transmitted to the data collection server device based on the measured value; and a wireless transmission section that transmits the communication data via wireless communication; and the data collection server device includes: a wireless reception section that receives the communication data transmitted from the measurement device via wireless communication; a remaining battery level calculation section that calculates a remaining battery level of the measurement device based on the received communication data; and an alarm output section that outputs an alarm about the remaining battery level of the measurement device based on a remaining battery level calculation result.

Japanese Patent Application No. 2007-233086, filed on Sep. 7, 2007, is hereby incorporated by reference in its entirety.

### BACKGROUND OF THE INVENTION

The present invention relates to a remaining battery level management system and a method of controlling the same.

Most battery management systems and battery checkers currently on the market estimate the remaining battery level based on the voltage between the terminals of the battery. Specifically, the voltage between the terminals of the battery is measured, and the remaining battery level is estimated based on a decrease in voltage between the terminals due to a decrease in battery capacity.

Although information such as the operation history of the device may be used supplementarily in order to improve the estimation accuracy, related-art technologies almost necessarily measure the voltage between the terminals (see JP-A-2004-157074 and JP-A-2006-53026).

A known battery capacity control method can be used for devices by using a manganese dry battery (primary battery) or a secondary battery (e.g., nickel-cadmium battery) without causing problems. However, a lithium-ion battery (lithium battery) that uses lithium for the negative electrode does not show a decrease in voltage until the battery is almost exhausted, and then shows a final rapid decrease in voltage. Therefore, it is difficult to provide a sufficient period before the operation of the device stops after outputting a battery level decrease alarm.

Since a device driven by a small battery (e.g., button battery) has a small capacity, it is necessary to decrease the amount of power consumed to monitor the remaining battery level as much as possible. Since such a device uses a small-capacity battery, power consumed by monitoring the remaining battery level cannot be disregarded particularly when the device uses a primary battery.

Moreover, the operation after outputting a remaining battery level decrease alarm cannot be ensured. As mentioned above, a lithium battery has discharging characteristics in which the voltage decreases rapidly when the remaining battery level has decreased to almost zero. Therefore, the period of time in which the device can operate after an alarm has been output cannot be determined by voltage monitoring. In the worst case, the device stops operation immediately after an alarm has been output. When an alarm is overlooked or the battery cannot be replaced immediately after an alarm has been output, the device may stop operation due to battery exhaustion.

Moreover, an increase in cost necessarily occurs when providing a remaining battery level monitoring mechanism (e.g. terminal-to-terminal voltage measurement mechanism).

### SUMMARY

According to a first aspect of the invention, there is provided a remaining battery level management system including a battery-driven measurement device and a data collection server device that collects a measured value obtained by the measurement device,

the measurement device including:

a communication data generation section that generates communication data to be transmitted to the data collection server device based on the measured value; and

a wireless transmission section that transmits the communication data via wireless communication; and

the data collection server device including:

a wireless reception section that receives the communication data transmitted from the measurement device via wireless communication;

a remaining battery level calculation section that calculates a remaining battery level of the measurement device based on the received communication data; and

an alarm output section that outputs an alarm about the remaining battery level of the measurement device based on a remaining battery level calculation result.

According to a second aspect of the invention, there is provided a remaining battery level management system including a battery-driven measurement device and a data collection server device that collects a measured value obtained by the measurement device,

the measurement device including:

a non-volatile storage section;

an operation history acquisition section that stores operation history information about a predetermined operation in the non-volatile storage section;

a communication data generation section that generates communication data to be transmitted to the data collection server device based on the operation history information stored in the non-volatile storage section; and

a wireless transmission section that transmits the communication data via wireless communication; and

the data collection server device including:

a wireless reception section that receives the communication data transmitted from the measurement device via wireless communication;

a remaining battery level calculation section that calculates a remaining battery level of the measurement device based on the operation history information included in the received communication data; and

an alarm output section that outputs an alarm about the remaining battery level of the measurement device based on a remaining battery level calculation result.

According to a third aspect of the invention, there is provided a remaining battery level management system including a data collection server device that collects a measured value obtained by a battery-driven measurement device,

the data collection server device including:

a wireless reception section that receives communication data transmitted from the measurement device via wireless communication;

a remaining battery level calculation section that calculates a remaining battery level of the measurement device based on at least one of the received communication data and operation history information included in the received communication data; and

a remaining battery level information output section that outputs remaining battery level information that informs of the remaining battery level of the measurement device based on a remaining battery level calculation result.

According to a fourth aspect of the invention, there is provided a remaining battery level management system including a battery-driven measurement device that transmits a measured value to a data collection server device,

the measurement device including:

a non-volatile storage section;

an operation history acquisition section that stores operation history information about a predetermined operation in the non-volatile storage section;

a communication data generation section that generates communication data to be transmitted to the data collection server device based on the operation history information stored in the non-volatile storage section; and

a wireless transmission section that transmits the communication data via wireless communication.

According to a fifth aspect of the invention, there is provided a method of controlling a remaining battery level management system including a battery-driven measurement device and a data collection server device that collects a measured value obtained by the measurement device,

the method causing the measurement device to perform:

a communication data generation step of generating communication data to be transmitted to the data collection server device based on the measured value; and

a wireless transmission step of transmitting the communication data via wireless communication; and

the method causing the data collection server device to perform:

a wireless reception step of receiving the communication data transmitted from the measurement device via wireless communication;

a remaining battery level calculation step of calculating a remaining battery level of the measurement device based on the received communication data; and

an alarm output step of outputting an alarm about the remaining battery level of the measurement device based on a remaining battery level calculation result.

According to a sixth aspect of the invention, there is provided a method of controlling a remaining battery level management system including a battery-driven measurement device and a data collection server device that collects a measured value obtained by the measurement device,

the method causing the measurement device to perform:

an operation history acquisition step of storing operation history information about a predetermined operation in a non-volatile storage section;

a communication data generation step of generating communication data to be transmitted to the data collection server device based on the operation history information stored in the non-volatile storage section; and

a wireless transmission step of transmitting the communication data via wireless communication; and

the method causing the data collection server device to perform:

a wireless reception step of receiving the communication data transmitted from the measurement device via wireless communication;

a remaining battery level calculation step of calculating a remaining battery level of the measurement device based on the operation history information included in the received communication data; and

an alarm output step of outputting an alarm about the remaining battery level of the measurement device based on a remaining battery level calculation result.

### BRIEF DESCRIPTION OF THE SEVERAL VIEWS OF THE DRAWING

FIG. 1 is a diagram illustrative of the configuration of a remaining battery level management system according to one embodiment of the invention.

FIG. 2 is a flowchart showing the flow of a process performed by a measurement device of a remaining battery level management system according to a first embodiment of the invention.

FIG. 3 is a flowchart showing the flow of a process performed by a data collection server device of the remaining battery level management system according to the first embodiment.

FIGS. 4A and 4B are diagrams illustrative of an operation history of the measurement device and an example of information stored in a non-volatile storage section of the measurement device.

FIGS. 5A to 5D are diagrams illustrative of communication data to be transmitted to a data collection server device and a remaining battery level calculation method based on the communication data.

FIGS. 6A and 6B are diagrams illustrative of an operation mode history of the measurement device and an example of information stored in the non-volatile storage section of the measurement device.

FIGS. 7A and 7B are diagrams illustrative of communication data and a remaining battery level calculation method.

FIG. 8 is a flowchart showing the flow of a process performed by a measurement device of a remaining battery level management system according to a second embodiment of the invention.

### DETAILED DESCRIPTION OF THE EMBODIMENT

The invention may provide a remaining battery level management system that can inform of a decrease in remaining battery level without providing a remaining battery level monitoring mechanism.

(1) According to one embodiment of the invention, there is provided a remaining battery level management system including a battery-driven measurement device and a data collection server device that collects a measured value obtained by the measurement device,

the measurement device including:

a communication data generation section that generates communication data to be transmitted to the data collection server device based on the measured value; and

a wireless transmission section that transmits the communication data via wireless communication; and

the data collection server device including:

a wireless reception section that receives the communication data transmitted from the measurement device via wireless communication;

a remaining battery level calculation section that calculates a remaining battery level of the measurement device based on the received communication data; and

an alarm output section that outputs an alarm about the remaining battery level of the measurement device based on a remaining battery level calculation result.

The measurement device is a battery-driven device that measures a given physical quantity (e.g., temperature, humidity, or quantity of light). The measurement device may include a sensor or the like that measures a given physical quantity.

The remaining battery level management system according to this embodiment is configured to include at least one measurement device and the data collection server device.

The data collection server device receives the communication data from one or more measurement devices, and calculates the remaining battery level of the measurement device that has transmitted the communication data based on the received communication data.

The remaining battery level of the measurement device may be calculated based on the data included in the communication data, or based on a communication data reception event. For example, when the data collection server device has received the communication data, the measurement device has performed a transmission operation. Therefore, the data collection server device can determine that the battery of the measurement device has been consumed due to the transmission operation. When the measurement device configured to regularly perform the measurement operation and the transmission operation performs n measurement operations and then performs one transmission operation, when the data collection server device has received the communication data, the measurement device has performed n measurement operations. Therefore, the data collection server device can determine that the battery of the measurement device has been consumed due to the n measurement operations. Therefore, the data collection server device may determine the operation of the measurement device based on reception of the communication data to calculate the battery consumption.

When the measurement device performs almost the same operation corresponding to each communication data transmission operation, the data collection server device may take statistics of the relationship between the number of communication operations and the battery consumption of the measurement device to determine the battery consumption corresponding to one communication data transmission operation in advance, and calculate the battery consumption based on the number of pieces of communication data transmitted from the measurement device.

The alarm output section may output an alarm or the like or may display an alert message, an alarm image, or the like on a display section when the remaining battery level has become equal to or less than a predetermined value. The threshold value of the remaining battery level at which an alarm is output may be arbitrarily set.

According to this embodiment, the data collection server device can calculate the remaining battery level of the measurement device by receiving the measured value obtained by the measurement device as the communication data.

According to this embodiment, a remaining battery level management system that can inform of a decrease in remaining battery level, consumes only a small amount of power, and provides a sufficient period before the operation of the device stops due to a decrease in remaining battery level, can be provided without providing a remaining battery level monitoring mechanism.

(2) In this remaining battery level management system,

the measurement device may include:

a non-volatile storage section; and

a measured value acquisition section that acquires the measured value and stores the acquired measured value in the non-volatile storage section; and

the communication data generation section may generate the communication data based on the measured value stored in the non-volatile storage section.

For example, the measured value may be stored in the non-volatile storage section corresponding to each measurement, and the communication data may be generated by reading the measured value corresponding to n measurements from the non-volatile storage section each time the n measurements have been completed, and transmitted to the data collection server device.

(3) According to one embodiment of the invention, there is provided a remaining battery level management system including a battery-driven measurement device and a data collection server device that collects a measured value obtained by the measurement device,

the measurement device including:

a non-volatile storage section;

an operation history acquisition section that stores operation history information about a predetermined operation in the non-volatile storage section;

a communication data generation section that generates communication data to be transmitted to the data collection server device based on the operation history information stored in the non-volatile storage section; and

a wireless transmission section that transmits the communication data via wireless communication; and

the data collection server device including:

a wireless reception section that receives the communication data transmitted from the measurement device via wireless communication;

a remaining battery level calculation section that calculates a remaining battery level of the measurement device based on the operation history information included in the received communication data; and

an alarm output section that outputs an alarm about the remaining battery level of the measurement device based on a remaining battery level calculation result.

The measurement device is a battery-driven device that measures a given physical quantity (e.g., temperature, humidity, or quantity of light). The measurement device may include a sensor or the like that measures a given physical quantity.

The remaining battery level management system according to this embodiment includes at least one measurement device and the data collection server device. The data collection server device receives the communication data from one or more measurement devices, and calculates the remaining battery level of the measurement device that has transmitted the communication data based on the operation history information included in the received communication data.

The remaining battery level calculation section may classify the operations of the measurement device depending on the power consumption, calculate the cumulative power consumption corresponding to each operation at regular time intervals based on the operation history information (e.g., the operation time and the number of operations immediately after battery replacement), and calculate the cumulative power consumption of the entire measurement device from the resulting value to estimate the remaining battery level.

For example, the operation type and the battery consumption consumed by one operation of the operation type may be set in the form of a weighting factor, the type of operation and the number of operations performed by the measurement device in a period from the preceding transmission to the present transmission may be determined from the operation history information, and the remaining battery level may be calculated based on the determination result and the weighting factor. The battery consumption corresponding to the type of operation and the number of operations may be measured and statistically analyzed, and each weighting factor may be set based on the analysis results.

Since the operation history information is stored in the non-volatile storage section, the measurement device can hold the operation history information without consuming power. Therefore, only a timer may be operated during standby while stopping the operation of a microcomputer that controls the measurement device. Since the operation history information is stored in the non-volatile storage section, the cumulative value after battery replacement can be reliably maintained. The measurement device does not necessarily successively perform measurements, but may be turned OFF. Since the data is stored in the non-volatile storage section, the operation history information after battery replacement can be maintained. Therefore, subsequent historical information can be added to the operation history information after power has been again supplied to the measurement device. The measured value may also be stored in the non-volatile storage section in addition to the operation history information.

According to this embodiment, since the operation history information is regularly transmitted to the data acquisition server, the data collection server device can calculate the cumulative power consumption due to each operation, calculate the cumulative power consumption of the entire measurement device, and estimate the remaining battery level. Therefore, since the load imposed on the measurement device side can be reduced, power consumption can be further reduced.

The alarm output section may output an alarm or the like or may display an alert message, an alarm image, or the like on a display section when the remaining battery level has become equal to or less than a predetermined value. The threshold value of the remaining battery level at which an alarm is output may be arbitrarily set.

According to this embodiment, the data collection server device can calculate the remaining battery level of the measurement device by receiving the operation history information of the measurement device.

Therefore, a remaining battery level management system that can inform of a decrease in remaining battery level, consumes only a small amount of power, and provides a sufficient period before the operation of the device stops due to a decrease in remaining battery level, can be provided without providing a remaining battery level monitoring mechanism.

(4) According to one embodiment of the invention, there is provided a remaining battery level management system including a data collection server device that collects a measured value obtained by a battery-driven measurement device,

the data collection server device including:

a wireless reception section that receives communication data transmitted from the measurement device via wireless communication;

a remaining battery level calculation section that calculates a remaining battery level of the measurement device based on at least one of the received communication data and operation history information included in the received communication data; and

a remaining battery level information output section that outputs remaining battery level information that informs of the remaining battery level of the measurement device based on a remaining battery level calculation result.

(5) In this remaining battery level management system, the operation history information may include operation mode history information about an operation mode history when the measurement device is operable in a plurality of operation modes that differ in power consumption; and

the remaining battery level calculation section may calculate the remaining battery level of the measurement device while reflecting the difference in battery consumption between the plurality of operation modes based on the operation mode history information.

The operation mode history information may be the switch time of each operation mode or the cumulative time of each operation mode in a predetermined period (i.e., a period from the preceding operation mode history transmission to the present operation mode history transmission), for example.

According to this embodiment, the data collection server device can determine each operation mode and the cumulative operation time in each operation mode when the measurement device can be operated in a plurality of modes that differ in power consumption. Therefore, even when the measurement device can be operated in a plurality of modes that differ in power consumption, a remaining battery level management system that can inform of a decrease in remaining battery level, consumes only a small amount of power, and provides a sufficient period before the operation of the device stops due to a decrease in remaining battery level can be provided without providing a remaining battery level monitoring mechanism.

(6) In this remaining battery level management system,

the operation history information may include information about the number of measurements performed by the measurement device; and

the remaining battery level calculation section may calculate the remaining battery level of the measurement device based on the number of measurements performed by the measurement device.

When the measurement device irregularly performs measurements (e.g., when the measurement device performs measurements when a predetermined measurement event has occurred), or the measured value is transmitted to the data collection server device only when the measured value satisfies a predetermined condition, the data collection server device cannot determine the number of measurement operations performed by the measurement device from the communication data received from the measurement device.

According to this embodiment, however, since the data collection server device can receive the number of measurement operations performed by the measurement device as the operation history information, a remaining battery level management system that can inform of a decrease in remaining battery level, consumes only a small amount of power, and provides a sufficient period before the operation of the device stops due to a decrease in remaining battery level can still be provided without providing a remaining battery level monitoring mechanism.

(7) According to one embodiment of the invention, there is provided a remaining battery level management system including a battery-driven measurement device that transmits a measured value to a data collection server device,

the measurement device including:

a non-volatile storage section;

an operation history acquisition section that stores operation history information about a predetermined operation in the non-volatile storage section;

a communication data generation section that generates communication data to be transmitted to the data collection server device based on the operation history information stored in the non-volatile storage section; and

a wireless transmission section that transmits the communication data via wireless communication.

For example, the operation history acquisition section of the measurement device may classify the operations depending on the power consumption, store the operation history information (e.g., the operation time and the number of operations immediately after battery replacement) in the non-volatile storage section, calculate the cumulative power consumption corresponding to each operation at regular time intervals, and calculate the cumulative power consumption of the entire measurement device from the resulting value to estimate the remaining battery level.

Since the operation history information is stored in the non-volatile storage section, the measurement device can hold the operation history information without consuming power. Therefore, only a timer may be operated during standby while stopping the operation of a microcomputer that controls the measurement device. Since the operation history information is stored in the non-volatile storage section, the cumulative value after battery replacement can be reliably maintained. The measurement device does not necessarily successively perform measurements, but may be turned OFF. Since the data is stored in the non-volatile storage section, the operation history information after battery replacement can be maintained. Therefore, subsequent historical information can be added to the operation history information after power has been again supplied to the measurement device.

(8) In this remaining battery level management system, the measurement device may include a remaining battery level calculation section that calculates a remaining battery level of the measurement device based on the operation history information stored in the non-volatile storage section.

According to this embodiment, the measurement device can calculate its own remaining battery level.

(9) In this remaining battery level management system, the communication data generated by the communication data generation section may include information about the remaining battery level of the measurement device.

According to this embodiment, the measurement device can notify the data collection server device of the calculated remaining battery level.

(10) This remaining battery level management system may further comprise an alarm output section that outputs an alarm about the remaining battery level of the measurement device based on a remaining battery level calculation result.

According to this embodiment, the measurement device itself can output an alarm about the remaining battery level.

(11) In this remaining battery level management system, the non-volatile storage section may include a ferroelectric memory.

The ferroelectric memory is an FeRAM, for example.

The ferroelectric memory can be rewritten by a number significantly larger than that of a flash memory and an EEPROM. Moreover, the ferroelectric memory can be rewritten within a short time.

Therefore, when the non-volatile storage section is formed using a ferroelectric memory, unnecessary information can be overwritten. Therefore, the non-volatile storage section can be implemented with a relatively small memory area, although the number of write operations increases.

(12) According to one embodiment of the invention, there is provided a method of controlling a remaining battery level management system including a battery-driven measurement device and a data collection server device that collects a measured value obtained by the measurement device,

the method causing the measurement device to perform:

a communication data generation step of generating communication data to be transmitted to the data collection server device based on the measured value; and

a wireless transmission step of transmitting the communication data via wireless communication; and

the method causing the data collection server device to perform:

a wireless reception step of receiving the communication data transmitted from the measurement device via wireless communication;

a remaining battery level calculation step of calculating a remaining battery level of the measurement device based on the received communication data; and

an alarm output step of outputting an alarm about the remaining battery level of the measurement device based on a remaining battery level calculation result.

(13) According to one embodiment of the invention, there is provided a method of controlling a remaining battery level management system including a battery-driven measurement device and a data collection server device that collects a measured value obtained by the measurement device,

the method causing the measurement device to perform:

an operation history acquisition step of storing operation history information about a predetermined operation in a non-volatile storage section;

a communication data generation step of generating communication data to be transmitted to the data collection server device based on the operation history information stored in the non-volatile storage section; and

a wireless transmission step of transmitting the communication data via wireless communication; and

the method causing the data collection server device to perform:

a wireless reception step of receiving the communication data transmitted from the measurement device via wireless communication;

a remaining battery level calculation step of calculating a remaining battery level of the measurement device based on the operation history information included in the received communication data; and

an alarm output step of outputting an alarm about the remaining battery level of the measurement device based on a remaining battery level calculation result.

Some embodiments of the invention will be described below, with reference to the drawings. Note that the invention is not limited to the following embodiments. The invention includes configuration in which the elements in the following description are arbitrarily combined.

### 1. Configuration

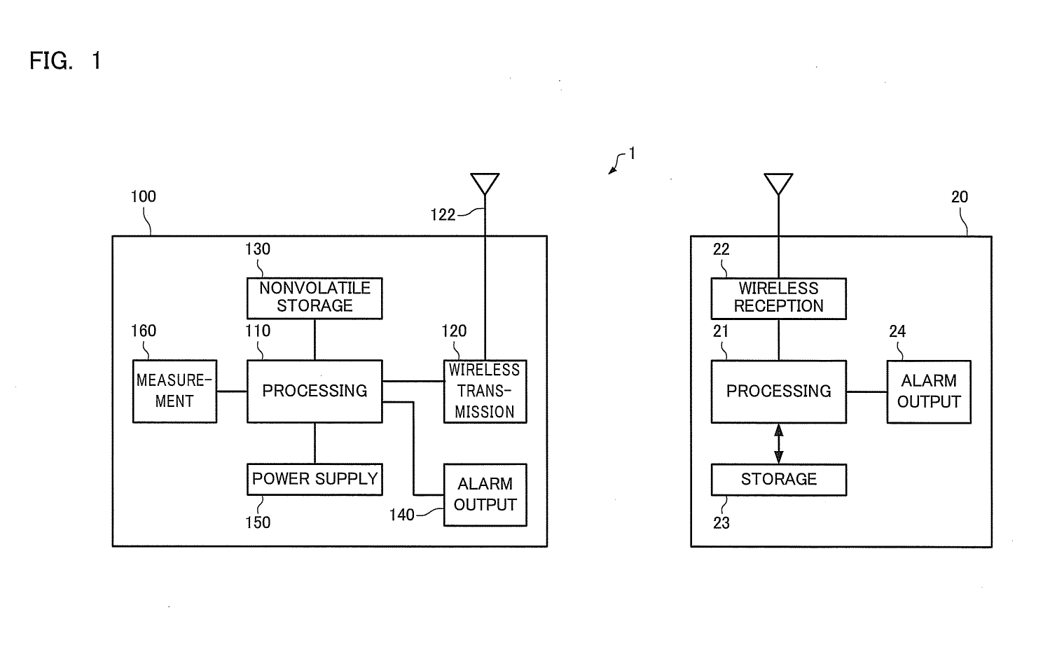

FIG. 1 is a diagram illustrative of the configuration of a remaining battery level management system according to one embodiment of the invention.

The remaining battery level management system 1 according to this embodiment includes a battery-driven measurement device 100, and a data collection server device 20 that receives a measured value obtained by the measurement device 100.

The remaining battery level management system 1 according to this embodiment may be configured to include one or more measurement devices 100 and the data collection server device 20. The remaining battery level management system 1 may be configured to include at least one data collection server device 20. The remaining battery level management system 1 may be configured to include at least one measurement device 100.

The measurement device 100 includes a processing section 110. The processing section 110 controls the operation of the entire measurement device, for example. The function of the processing section 110 may be implemented by hardware such as a processor (e.g., CPU), a microcomputer, or an ASIC (e.g., gate array) and a given program (e.g., microprogram).

The processing section 110 functions as a communication data generation section that generates communication data to be transmitted to the data collection server device based on the measured value obtained by a measurement section 160.

The processing section 110 may function as a measured value acquisition section that acquires the measured value obtained by the measurement section 160 and stores the measured value in a non-volatile storage section 130.

The processing section 110 may function as an operation history acquisition section that stores an operation history relating to a predetermined operation in the non-volatile storage section 130. In this case, the processing section 110 may generate the communication data to be transmitted to the data collection server device based on operation history information stored in the non-volatile storage section 130.

The processing section 110 may function as a remaining battery level calculation section that calculates information about the remaining battery level of the measurement device based on the operation history information stored in the non-volatile storage section. The processing section 110 may generate the communication data to be transmitted to the data collection server device based on the measured value obtained by the measurement section 160 and the information about the remaining battery level of the measurement device.

The measurement device 100 includes a wireless transmission section 120. The wireless transmission section 120 transmits data via wireless communication. For example, the wireless transmission section 120 is implemented by an RFIC or the like. The wireless transmission section 120 transmits measurement information via wireless communication.

The measurement device 100 includes a non-volatile storage section 130. The non-volatile storage section 130 may be formed using a flash memory, an EEPROM, or a ferroelectric memory such as an FeRAM, for example.

The measurement device 100 includes the measurement section 160. For example, the measurement section 160 is formed using a sensor that measures a given physical quantity (e.g., temperature, humidity, or quantity of light).

The measurement device 100 includes a power supply section 150. For example, the power supply section 150 may be a primary battery (e.g., manganese dry battery), a secondary battery (e.g., nickel-cadmium battery), or the like. In this embodiment, the remaining level of the battery that forms the power supply section 150 is calculated, and the remaining battery level is managed so that battery exhaustion does not occur.

The measurement device 100 may include an alarm output section 140 that outputs an alarm about the remaining battery level of the measurement device based on the remaining battery level calculation result. The alarm output section 140 may be implemented by outputting an alarm sound (alarm) or blinking an LED on and off, for example.

The data collection server device is a computer or the like that receives the measured value transmitted from the measurement device, and stores and manages the measured value or controls the system based on the measured value, for example.

The data collection server device 20 includes a processing section 21. The processing section 21 controls the operation of the entire data collection server device, for example. The function of the processing section 21 may be implemented by hardware such as a processor (e.g., CPU) or an ASIC (e.g., gate array) and a given program (e.g., microprogram).

The processing section 21 functions as a remaining battery level calculation section that calculates the remaining battery level of the measurement device based on the received communication data. The processing section 21 may calculate the remaining battery level of the measurement device based on at least one of the measured value obtained by the measurement device and the operation history information of the measurement device included in the received the communication data.

The remaining battery level may be calculated regularly, or may be calculated each time the communication data has been received from the measurement device, or may be calculated at a predetermined remaining battery level calculation timing.

The remaining battery level may be calculated based on the communication data received from the communication device after the battery of the measurement device has been replaced. The remaining battery level may be calculated based only on the newly received communication data, or may be calculated based on the newly received communication data and the previously received communication data. Note that the received communication data may be stored in a storage section 23, and the remaining battery level may be calculated based on necessary data read from the storage section 23 at a predetermined timing.

The data collection server device 20 includes a wireless reception section 22. The wireless reception section 22 receives data via wireless communication. The wireless reception section 22 receives the communication data transmitted from the measurement device via wireless communication.

The data collection server device 20 includes a storage section 23. The storage section 23 stores a program, data, and the like. The function of the storage section 23 may be implemented by an optical disk (CD or DVD), a hard disk, a memory card, a memory cassette, a magnetic disk, a memory (ROM), or the like.

The data collection server device 20 includes an alarm output section 24 that outputs an alarm about the remaining battery level of the measurement device based on the remaining battery level calculation result. The alarm output section 24 may output an alarm image or an alarm (text) message on a display section (e.g., LCD), or output a voice message or the like from a speaker or the like.

### 2. Process According to First Embodiment

A remaining battery level management system according to a first embodiment is configured so that the processing section 21 of the data collection server device 20 calculates the remaining battery level based on the communication data received from the measurement device 100, and the alarm output section 24 of the data collection server device outputs an alarm based on the calculation result.

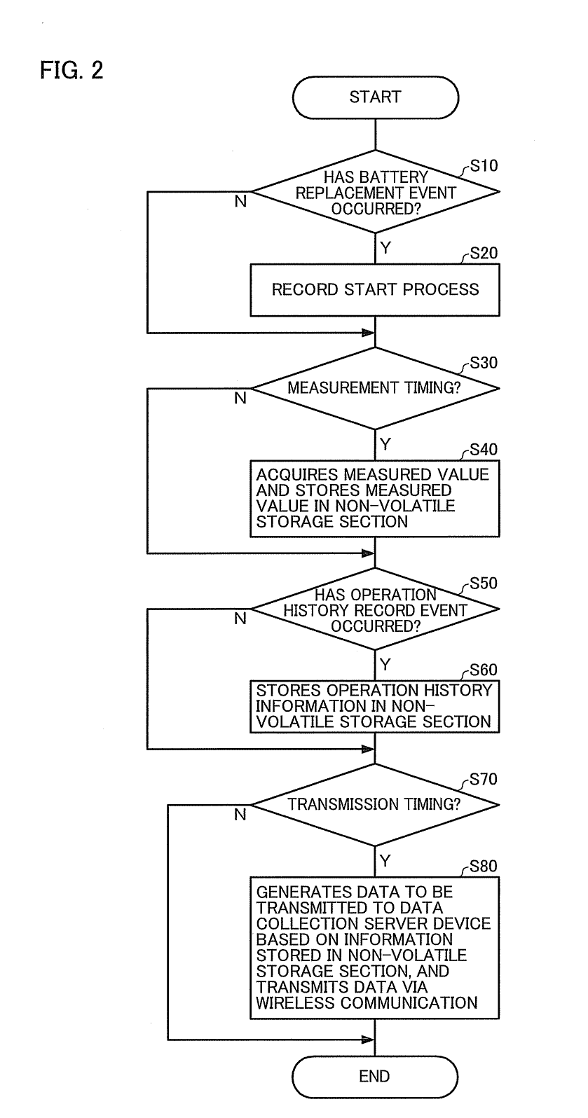

FIG. 2 is a flowchart showing the flow of a process performed by the measurement device 100 of the remaining battery level management system according to the first embodiment.

When the measurement device 100 has detected occurrence of a battery replacement event (step S10), the measurement device 100 performs a record start process (step S20). As the record start process, the measurement device 100 may perform a process necessary for clearing the operation history which has been stored in the non-volatile storage section 130 and recording a new operation history, or may perform a process necessary for recording the battery replacement date and recording the operation history so that the operation history before battery replacement can be distinguished from the operation history after battery replacement.

The measurement device 100 then determines whether or not a predetermined measurement timing has occurred (step S30). When the measurement timing has occurred, the measurement device 100 acquires the measured value obtained by the measurement section and stores the measured value in the non-volatile storage section (step S40).

Whether or not the predetermined measurement timing has occurred may be determined using a timer or the like. For example, when the measurement device acquires the measured value once per unit time, the measurement timing occurs every unit time. When the measurement device acquires the measured value once a day, the measurement timing occurs every day. The measurement timing may be a timing at which the measured value is acquired from the measurement section that always measures a given physical quantity, or a timing at which the measurement section that operates only during measurement measures a given physical quantity.

Note that all measured values acquired at the measurement timing may be stored in the non-volatile storage section, or the measured value may be stored in the non-volatile storage section only when the measured value satisfies a predetermined condition, for example.

When an operation history record event has occurred (step S50), the measurement device 100 stores the operation history information in the non-volatile storage section (step S60). The operation history record event may be a data transmission event, for example. When the measurement device is automatically set in a power saving mode under predetermined conditions, the operation history record event may be a power saving mode transition event or a normal mode recovery event. When the operation history record event has occurred, the measurement device 100 may store the event occurrence date (date and time) and the event type in the non-volatile storage section as the operation history information.

The measurement device 100 then determines whether or not a transmission timing has occurred (step S70). When the transmission timing has occurred, the measurement device 100 generates the communication data to be transmitted to the data collection server device based on the information stored in the non-volatile storage section, and transmits the communication data via wireless communication (step S80). The communication data to be transmitted by the measurement device 100 relates to the measured value and the operation history during a period from the preceding transmission to the present time. The communication data may be generated based on information relating to that period stored in the non-volatile storage section.

Whether or not the transmission timing has occurred may be determined using a timer or the like. For example, the transmission timing may be set corresponding to one measurement timing, or may be set corresponding to a plurality of measurement timings. In the latter case, data may be measured n times, and the n pieces of data may be transmitted collectively. According to this configuration, since the number of transmission operations can be reduced, the life of the battery of the communication device can be increased.

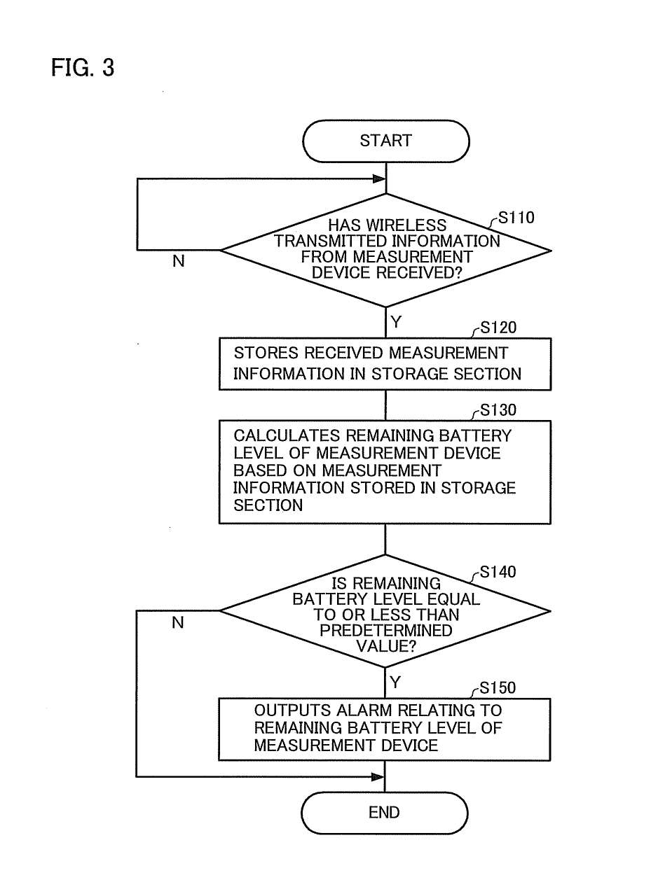

FIG. 3 is a flowchart showing the flow of a process performed by the data collection server device 20 of the remaining battery level management system according to the first embodiment.

When the data collection server device 20 has received the communication data transmitted from the measurement device 100 via wireless communication (step S110), the data collection server device 20 stores the received communication data in the storage section (step S120).

The data collection server device 20 then calculates the remaining battery level of the measurement device based on the measurement information stored in the storage section (step S130).

When the remaining battery level is equal to or less than a predetermined value (step S140), the data collection server device 20 outputs an alarm about the remaining battery level of the measurement device (step S150). The predetermined value as the alarm output criterion may be appropriately set corresponding to the type of battery and the like. The predetermined value may be changed externally. A plurality of remaining battery level threshold values may be set as alarm output target values in a state in which the battery has not been consumed to a large extent so that an alarm is output in multiple stages.

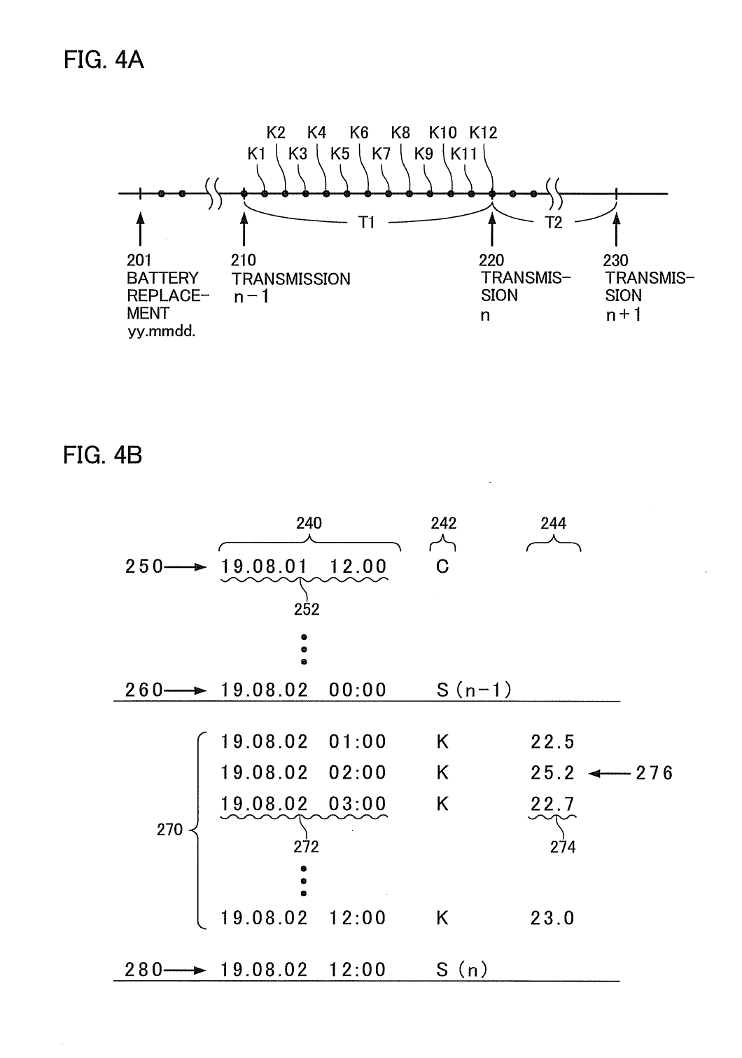

FIGS. 4A and 4B are diagrams illustrative of the operation history of the measurement device 100 and an example of the information stored in the non-volatile storage section 130 of the measurement device 100. The following example is given taking an example in which the temperature management measurement device measures temperature.

FIG. 4A is a diagram showing the operation history of the measurement device in time series. Reference numeral 201 indicates that the battery replacement event occurred on the date yymmdd. The measurement device is configured to acquire the temperature measured by a temperature measurement section each time the unit time has elapsed, as indicated by K1 (01:00), K2 (02:00), K3 (03:00), . . . , and K12 (12:00). As indicated by reference numerals 210 and 220, the measurement device is configured to transmit the measurement result to the data collection server device 20 twice (00:00 and 12:00) a day (every 12 hours).

FIG. 4B shows the information stored in the non-volatile storage section of the measurement device. FIG. 4B shows a state in which the operation history (e.g., battery replacement and transmission) of the measurement device and log data of the measured value obtained by the measurement section are stored in the non-volatile storage section. The log data (log information about each operation) may include date information 240 (i.e., the date when each operation was performed), an operation type 242 (i.e., the type of each operation), and a measured value 244 (when the operation is a measurement operation). A log target operation may be determined in advance, and the log information may be recorded when the log target operation has been performed.

Reference numeral 270 indicates the log information about the measurement operation performed each time the unit time has elapsed. Note that measurement time information 272 may be omitted when the temperature is measured at measurement times with a predetermined pattern, for example.

The measured value log data may be stored in the non-volatile storage section only when the measured value satisfies a predetermined condition. For example, the measured value log data may not be stored in the non-volatile storage section when the measured value is in the range from 22 to 25, and may be stored in the non-volatile storage section only when the measured value is outside the range from 22 to 25. Specifically, the measured value log data may be stored in the non-volatile storage section only when the measured value is outside the range from 22 to 25 (see 276).

Reference numeral 250 indicates the log information about the battery replacement operation (see 201 in FIG. 4A). Reference numerals 260 and 280 indicate the log information about the transmission operation (see 210, 220, and 230 in FIG. 4A).

Note that the invention is not limited to the above embodiment described taking an example in which the operation history and the measured value are stored in the non-volatile storage section. For example, when the measurement device 100 does not transmit the operation history to the data acquisition server 20, only the measured value may be stored in the non-volatile storage section.

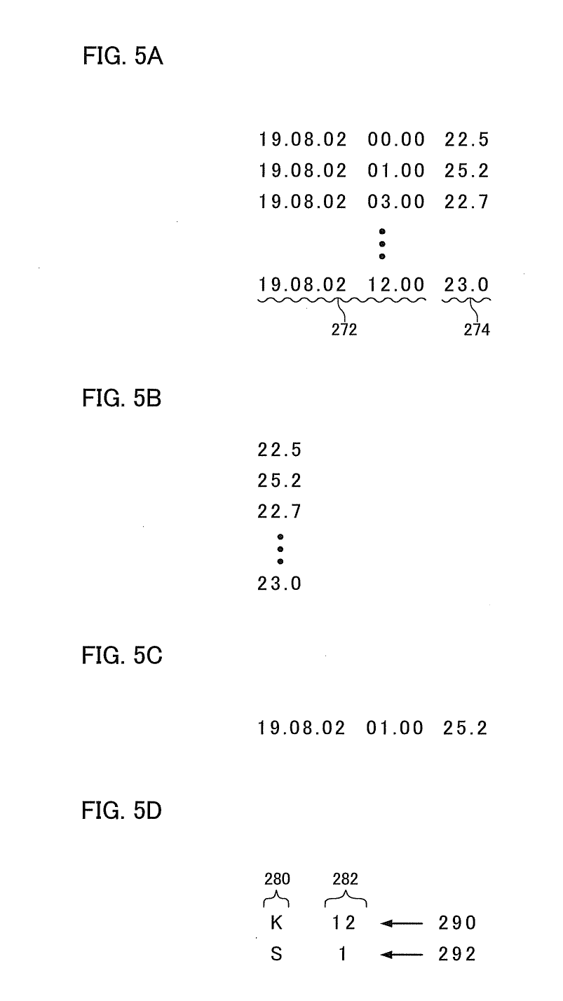

FIGS. 5A to 5D are diagrams illustrative of the communication data to be transmitted to the data collection server device and a remaining battery level calculation method based on the communication data.

FIGS. 5A to 5C show examples of the communication data generated based on the measured value. As shown in FIG. 5A, measured data 274 and the measurement time 272 may be generated as the communication data regarding the measured value which has not been transmitted (i.e., the measured value acquired in a period from the preceding transmission to the present time (present transmission)), for example.

When all of the acquired data is transmitted, the data collection server device 20 can determine the number of data acquisition operations (since all of the acquired data is transmitted in this case, the number of pieces of data is equal to the number of data acquisition operations) from the communication data. Specifically, the data collection server device 20 can determine that the measurement device has performed twelve measurement operations and one transmission operation by receiving the communication data.

For example, when the weighting factor for the measurement operation (per operation) and the weighting factor for the transmission operation (per operation) when calculating the remaining battery level are respectively referred to as a and b, and the number of measurement operations and the number of transmission operations in a period from the time when the battery has started to be used to the present time are respectively referred to as n and m, the battery consumption S until the present time may be approximated by the following equation.

S=a×n+b×m

When the number of measurement operations in a period from the preceding transmission to the present transmission is referred to as n′ and the number of transmission operations is one, the battery consumption S′ in a period from the preceding transmission to the present transmission may be approximated by the following equation.

S′=a×n′+b

Each weighting factor is set corresponding to the type of battery and the type of operation. The battery consumption corresponding to the type of operation and the number of operations may be measured and statistically analyzed, and each weighting factor may be set based on the analysis results. When different types of batteries may be used, the battery consumption corresponding to the type of operation and the number of operations may be measured and statistically analyzed corresponding to each type of battery, and each weighting factor may be set based on the analysis results.

Since the amount of power consumed by one measurement differs between the case where the measurement section always measures the temperature and case where the measurement section performs the measurement operation only during the measurement period, the weighting factor a for the measurement operation may be changed corresponding to the specification.

As shown in FIG. 5B, only the measured data 274 may be generated as the communication data regarding the measured value which has not been transmitted (i.e., the measured value acquired in a period from the preceding transmission to the present time (present transmission)), for example. When the measurement time is set to be constant (e.g., the temperature is measured from 0:00 each time the unit time has elapsed), the measurement time can be determined based on the order of the measured values even if the measurement time 272 is not provided. In this case, the remaining battery level can be calculated in the same manner as in the case shown in FIG. 5A.

As shown in FIG. 5C, the measured value that satisfies a predetermined condition (e.g., the measured value outside the range from 22 to 25) among the measured values which have not been transmitted (i.e., the measured values acquired in a period from the preceding transmission to the present time (present transmission)) may be used as the communication data, for example. In this case, since the data collection server device 20 can determine that the measurement device has performed twelve measurement operations and one transmission operation by receiving the communication data, the remaining battery level can be calculated in the same manner as in the case shown in FIG. 5A.

FIG. 5D shows an example of the communication data generated based on the operation history information. Reference numeral 280 indicates the operation type of the operation performed in the above-mentioned period, and reference numeral 282 indicates the number of operations specified by the operation type. When the operation time differs even if the operation type is identical, the cumulative operation time may also be included in the communication data.

When calculating the remaining battery level, the power consumption may be estimated from the operation type, the cumulative power consumption corresponding to each operation type may be calculated at regular time intervals based on the operation history information (e.g., the operation time and the number of operations corresponding to each operation type immediately after battery replacement), and the cumulative power consumption of the entire measurement device may be calculated from the resulting value to estimate the remaining battery level.

For example, when the cumulative number of operations corresponding to each operation type from the time when the battery has started to be used to the present time is A(1), A(2), . . . , and A(j) and the weighting factor for the cumulative number of operations corresponding to each operation type is e(1), e(2), . . . , and e(j), the cumulative battery consumption S may be approximated by the following equation.

S=A(1)×e(1)+A(2)×e(2)+ . . . +A(j)×e(j)

When the cumulative number of operations corresponding to each operation type from the preceding transmission to the present transmission is A′(1), A′(2), . . . , and A′(j) and the weighting factor for the cumulative number of operations corresponding to each operation type is e(1), e(2), . . . , and e(j), the battery consumption S′ from the preceding transmission to the present transmission may be approximated by the following equation.

S′=A′(1)×e(1)+A′(2)×e(2)+ . . . +A′(j)×e(j)

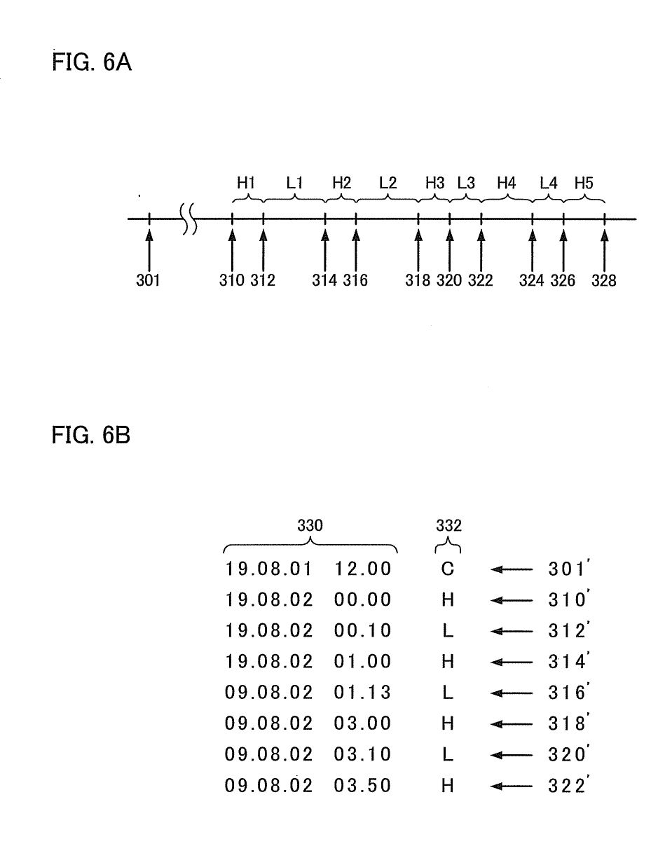

FIGS. 6A and 6B are diagrams illustrative of the operation mode history of the measurement device 100 and an example of the information stored in the non-volatile storage section 130 of the measurement device 100.

FIG. 6A is a diagram showing the operation history of the measurement device in time series. Reference numeral 301 indicates that the battery replacement event occurred on the date yymmdd. Reference numerals 310, 314, 318, 322, and 326 indicate a transition to the normal mode, and reference numerals 312, 316, 320, 324, and 328 indicate a transition to the power saving mode. Reference symbols H1, H2, H3, H4, and H5 indicate normal mode periods, and reference symbols L1, L2, L3, and L4 indicate power saving mode periods. As shown in FIG. 6A, the measurement device operates in the normal mode and the power saving mode that differ in power consumption. The measurement device operates in the normal mode when performing processes such as measurement, transmission, and data processing. When the measurement device has completed these processes, the measurement device automatically transitions to the power saving mode. When the measurement device has detected a normal mode transition event (note that a mechanism for detecting the next measurement event or an interrupt operates after the measurement device has transitioned to the power saving mode), the measurement device transitions from the power saving mode to the normal mode.

FIG. 6B shows the information stored in the non-volatile storage section of the measurement device. As shown in FIG. 6B, the operation history information about a change in operation mode (predetermined operation) may be stored in the non-volatile storage section.

Reference numeral 330 indicates the operation date, and reference numeral 332 indicates the operation type 254. An operation type C indicates the battery replacement operation, an operation type H indicates the normal mode transition operation, and an operation type L indicates the power saving mode transition operation. Reference numerals 301′ and 310′ to 322′ respectively correspond to the reference numerals 301 and 310 to 322 shown in FIG. 6A.

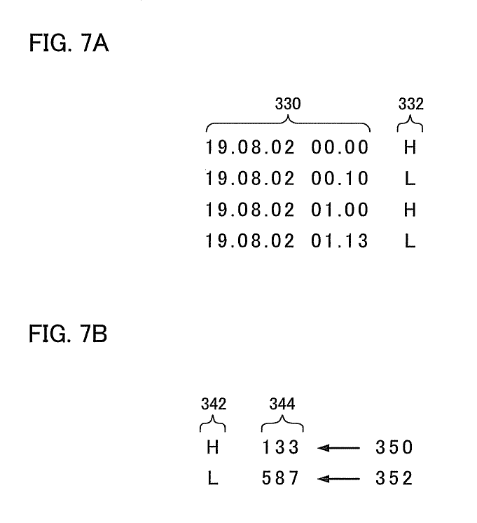

FIGS. 7A and 7B are diagrams illustrative of the communication data when the communication data to be transmitted to the data collection server device is generated based on the measured value, and a remaining battery level calculation method based on the communication data.

As shown in FIG. 7A, the operation date 330 and the operation type 332 may be generated as the communication data regarding the operation history information which has not been transmitted (i.e., a change in operation mode that has occurred in a period from the preceding transmission to the present time (present transmission)), for example. When transmitting the operation history (including the operation mode history), the communication data may be generated by adding the operation history (including the operation mode history) to the measured value, or may be generated by utilizing only the operation history (including the operation mode history).

In this case, the data collection server device can determine a normal mode operation time HT and a power saving mode operation time LT from the communication data. The data collection server device 20 can also determine that one transmission operation has been performed by receiving the communication data.

For example, the weighting factor per unit time in the normal mode when calculating the remaining battery level is referred to as c, the weighting factor per unit time in the power saving mode is referred to as d, and the weighting factor for the transmission operation is referred to as b. When the normal mode operation time, the power saving mode operation time, and the number of transmission operations in a period from the time when the battery has started to be used to the present time are respectively referred to as HT, LT, and m, the battery consumption S until the present time may be approximated by the following equation.

S=c×HT+d×LT+b×m

When the normal mode operation time and the power saving mode operation time in a period from the preceding transmission to the present transmission are respectively referred to as HT and LT and the number of transmission operations is one, the battery consumption S′ in a period from the preceding transmission to the present transmission may be approximated by the following equation.

S′(i)=c×LT′+d×LT′+b

The weighting factors c and d are set corresponding to the type of battery and the type of operation. The battery consumption corresponding to the operation mode and the operating time may be measured and statistically analyzed corresponding to each type of battery, and the weighting factors c and d may be set based on the analysis results.

Note that the battery consumption actually consumed may differ depending on the operation even if the operation mode is identical. Therefore, calculations of the battery consumption corresponding to the operation mode may be combined with calculations of the battery consumption corresponding to the operation.

As shown in FIG. 7B, an operation mode type 342 and a cumulative time 344 may be generated as the communication data regarding operation mode cumulative time information which has not been transmitted (i.e., the cumulative time of each operation mode that has occurred in a period from the preceding transmission to the present transmission). Reference numeral 350 indicates that the cumulative time of the normal mode is 133 minutes, and reference numeral 352 indicates that the cumulative time of the power saving mode is 352 minutes. In this case, the remaining battery level can be calculated in the same manner as in the case shown in FIG. 7A.

The above embodiment has been described taking an example in which the measurement device 100 transmits the information about the measured value and the operation mode, and the processing section 21 of the data collection server device 20 that has received the information calculates the remaining battery level based on the measured value and the operation mode. Note that the invention is not limited thereto. For example, the measurement device 100 may transmit information about the operation history of a predetermined operation (e.g., a measurement operation, a calculation operation relating to determination of the measured value, a write operation that writes to the storage section, a read operation that read from the storage section, a communication data generation operation, and a communication operation), and the processing section 21 of the data collection server device 20 that has received the information calculates the remaining battery level based on the operation history.

### 3. Process According to Second Embodiment

A remaining battery level management system according to a second embodiment is configured so that the measurement device 100 calculates the remaining battery level and the alarm output section 140 of the measurement device 100 outputs an alarm based on the calculation result.

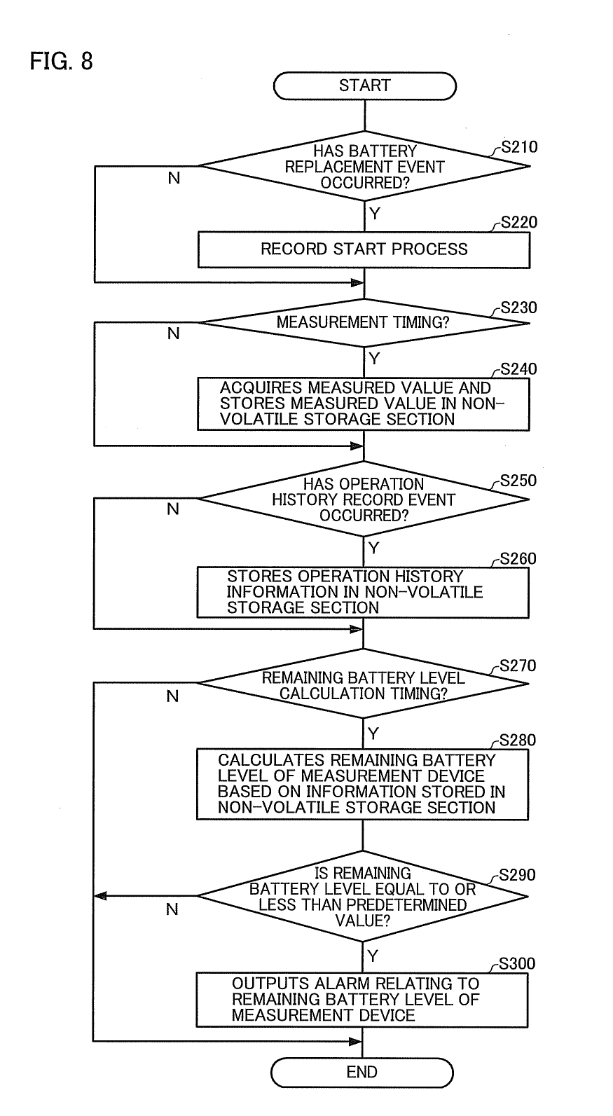

FIG. 8 is a flowchart showing the flow of a process performed by the measurement device 100 of the remaining battery level management system according to the second embodiment.

When the measurement device 100 has detected occurrence of a battery replacement event (step S210), the measurement device 100 performs a record start process (step S220).

The measurement device 100 then determines whether or not a predetermined measurement timing has occurred (step S230). When the measurement timing has occurred, the measurement device 100 acquires the measured value obtained by the measurement section and stores the measured value in the non-volatile storage section (step S240).

When the operation history record event has occurred (step S250), the measurement device 100 stores the operation history information in the non-volatile storage section (step S260).

The measurement device 100 then determines whether or not a remaining battery level calculation timing has occurred (step S270). When the remaining battery level calculation timing has occurred, the measurement device 100 calculates the remaining battery level of the measurement device based on the information stored in the non-volatile storage section (step S280). The remaining battery level may be calculated by using a method similar to those described with reference to FIGS. 5A to 5D and FIGS. 7A and 7B.

When the remaining battery level is equal to or less than a predetermined value (step S290), the measurement device 100 outputs an alarm about the remaining battery level of the measurement device (step S300).

According to the related-art technology, a decrease in remaining battery level is informed of by an alarm due to a decrease in voltage between the terminals of the battery, and the battery must be replaced immediately. According to the invention, the remaining battery level at which an alarm is output can be arbitrarily set. Therefore, the battery need not be replaced immediately after an alarm has been output. It is important that the measurement device that is successively used ensures uninterrupted measurements and allows maintenance (e.g., battery replacement) to be systematically performed with a minimum burden. Therefore, it is necessary to prevent interruption of measurements due to battery exhaustion rather than making full use of the battery. The invention is suitable for such applications.

Since the operation history information is stored in the non-volatile storage section, power to the measurement device including a microcomputer that controls the entire measurement device can be removed during standby. Since power is not necessarily always supplied to the measurement device, the information can be stored in the non-volatile storage section so that power may be removed at any time.

When the measurement device regularly transmits the stored data to the data acquisition server via wireless communication, the server may calculate the cumulative power consumption and estimate the remaining battery level. This makes it possible to cause the measurement device to perform only measurements and data storage. Therefore, a low-performance microcomputer can be utilized. As a result, power consumption can be reduced.

In order to improve the remaining battery level measurement accuracy, calculations necessarily become complicated. In this case, if the data acquisition server performs calculations, the calculation load imposed on the measurement device need not be taken into consideration.

Moreover, the invention has an advantage in that an alarm can be output in multiple stages in a state in which the battery has not been consumed to a large extent so that it is possible to systematically prepare for battery replacement.

The invention is not limited to the above-described embodiments, and various modifications can be made. For example, the invention includes various other configurations substantially the same as the configurations described in the embodiments (in function, method and result, or in objective and result, for example). The invention also includes a configuration in which an unsubstantial portion in the described embodiments is replaced. The invention also includes a configuration having the same effects as the configurations described in the embodiments, or a configuration able to achieve the same objective. Further, the invention includes a configuration in which a publicly known technique is added to the configurations in the embodiments.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. A remaining battery level management system including a battery-driven measurement device and a data collection server device that collects a measured value obtained by the measurement device,
the measurement device including:
a communication data generation section that generates communication data to be transmitted to the data collection server device based on the measured value; and
a wireless transmission section that transmits the communication data via wireless communication; and
the data collection server device including:
a wireless reception section that receives the communication data transmitted from the measurement device via wireless communication;
a remaining battery level calculation section that calculates a remaining battery level of the measurement device based on the received communication data; and
an alarm output section that outputs an alarm about the remaining battery level of the measurement device based on a remaining battery level calculation result.

2. The remaining battery level management system as defined in claim 1,
the measurement device including:
a non-volatile storage section; and
a measured value acquisition section that acquires the measured value and stores the acquired measured value in the non-volatile storage section; and
the communication data generation section generating the communication data based on the measured value stored in the non-volatile storage section.

3. A remaining battery level management system including a battery-driven measurement device and a data collection server device that collects a measured value obtained by the measurement device,
the measurement device including:
a non-volatile storage section;
an operation history acquisition section that stores operation history information about a predetermined operation in the non-volatile storage section;
a communication data generation section that generates communication data to be transmitted to the data collection server device based on the operation history information stored in the non-volatile storage section; and
a wireless transmission section that transmits the communication data via wireless communication; and
the data collection server device including:
a wireless reception section that receives the communication data transmitted from the measurement device via wireless communication;
a remaining battery level calculation section that calculates a remaining battery level of the measurement device based on the operation history information included in the received communication data; and
an alarm output section that outputs an alarm about the remaining battery level of the measurement device based on a remaining battery level calculation result.

4. A remaining battery level management system including a data collection server device that collects a measured value obtained by a battery-driven measurement device, the data collection server device including:
a wireless reception section that receives communication data transmitted from the measurement device via wireless communication;
a remaining battery level calculation section that calculates a remaining battery level of the measurement device based on at least one of the received communication data and operation history information included in the received communication data; and
a remaining battery level information output section that outputs remaining battery level information that informs of the remaining battery level of the measurement device based on a remaining battery level calculation result.

5. The remaining battery level management system as defined in claim 3,
the operation history information including operation mode history information about an operation mode history when the measurement device is operable in a plurality of operation modes that differ in power consumption; and
the remaining battery level calculation section calculating the remaining battery level of the measurement device while reflecting the difference in battery consumption between the plurality of operation modes based on the operation mode history information.

6. The remaining battery level management system as defined in claim 4,
the operation history information including operation mode history information about an operation mode history when the measurement device is operable in a plurality of operation modes that differ in power consumption; and
the remaining battery level calculation section calculating the remaining battery level of the measurement device while reflecting the difference in battery consumption between the plurality of operation modes based on the operation mode history information.

7. The remaining battery level management system as defined in claim 3,
the operation history information including information about the number of measurements performed by the measurement device; and
the remaining battery level calculation section calculating the remaining battery level of the measurement device based on the number of measurements performed by the measurement device.

8. The remaining battery level management system as defined in claim 4, the operation history information including information about the number of measurements performed by the measurement device; and
the remaining battery level calculation section calculating the remaining battery level of the measurement device based on the number of measurements performed by the measurement device.

9. A remaining battery level management system including a battery-driven measurement device that transmits a measured value to a data collection server device,
the measurement device including:
a non-volatile storage section;
an operation history acquisition section that stores operation history information about a predetermined operation in the non-volatile storage section;
a communication data generation section that generates communication data to be transmitted to the data collection server device based on the operation history information stored in the non-volatile storage section; and
a wireless transmission section that transmits the communication data via wireless communication.

10. The remaining battery level management system as defined in claim 9,
the measurement device including a remaining battery level calculation section that calculates a remaining battery level of the measurement device based on the operation history information stored in the non-volatile storage section.

11. The remaining battery level management system as defined in claim 10,
the communication data generated by the communication data generation section including information about the remaining battery level of the measurement device.

12. The remaining battery level management system as defined in claim 10, further comprising:
an alarm output section that outputs an alarm about the remaining battery level of the measurement device based on a remaining battery level calculation result.

13. The remaining battery level management system as defined in claim 2,
the non-volatile storage section including a ferroelectric memory.

14. The remaining battery level management system as defined in claim 3,
the non-volatile storage section including a ferroelectric memory.

15. The remaining battery level management system as defined in claim 9,
the non-volatile storage section including a ferroelectric memory.

16. A method of controlling a remaining battery level management system including a battery-driven measurement device and a data collection server device that collects a measured value obtained by the measurement device,
the method causing the measurement device to perform:
a communication data generation step of generating communication data to be transmitted to the data collection server device based on the measured value; and
a wireless transmission step of transmitting the communication data via wireless communication; and
the method causing the data collection server device to perform:
a wireless reception step of receiving the communication data transmitted from the measurement device via wireless communication;
a remaining battery level calculation step of calculating a remaining battery level of the measurement device based on the received communication data; and
an alarm output step of outputting an alarm about the remaining battery level of the measurement device based on a remaining battery level calculation result.

17. A method of controlling a remaining battery level management system including a battery-driven measurement device and a data collection server device that collects a measured value obtained by the measurement device,
the method causing the measurement device to perform:
an operation history acquisition step of storing operation history information about a predetermined operation in a non-volatile storage section;
a communication data generation step of generating communication data to be transmitted to the data collection server device based on the operation history information stored in the non-volatile storage section; and
a wireless transmission step of transmitting the communication data via wireless communication; and
the method causing the data collection server device to perform:
a wireless reception step of receiving the communication data transmitted from the measurement device via wireless communication;
a remaining battery level calculation step of calculating a remaining battery level of the measurement device based on the operation history information included in the received communication data; and
an alarm output step of outputting an alarm about the remaining battery level of the measurement device based on a remaining battery level calculation result.
